(19) United States
(12) Patent Application Publication
(10) Pub. No.: US 2012/0107025 A1
(43) Pub. Date: May 3, 2012

(54) IMAGE FORMING APPARATUS

(76) Inventor: Hirotaka OHSHIKA, Tokyo (JP)

(21) Appl. No.: 13/272,371

(22) Filed: Oct. 13, 2011

(30) Foreign Application Priority Data
Nov. 2, 2010 (JP) 2010-245957

(51) Int. Cl. G03G 15/14

(52) U.S. Cl. 399/315

(57) ABSTRACT

An image forming apparatus includes an image forming unit having an image supporting member for supporting a developer image; a transfer device for transferring the developer image on the image supporting member to a front surface of a recording medium; a neutralizing device disposed on a downstream side of the transfer device in a transportation direction of the recording medium and a side of a backside surface of the recording medium for neutralizing the recording medium with the developer image thus transferred; and a blocking member disposed at a position to face the neutralizing device for blocking the image supporting member from the neutralizing device.

### BACKGROUND OF THE INVENTION AND RELATED ART STATEMENT

The present invention relates to an image forming apparatus. More specifically, the present invention relates to an image forming apparatus using an electric-photography process such as a printer, a facsimile, and the like.

In a conventional image forming apparatus, it has been desirable to print on various types of recording media. To this end, a neutralizing device may be disposed in the conventional image forming apparatus on a downstream side of a transfer roller in a medium transportation path for applying an electrical field with an opposite polarity to a recording medium to remove static electricity (referred to as neutralizing).

With the configuration described above, for example, when the conventional image forming apparatus prints on a soft recording medium having low rigidity such as a recycles paper sheet, it is possible to prevent the soft recording medium charged with a positive polarity from being wound around a photosensitive drum by the transfer roller.

Patent Reference has disclosed such a conventional image forming apparatus, in which a discharging needle is disposed on the downstream side of the transfer roller for applying a separation bias to the recording medium transported thereto. Further, a grounded neutralizing needle is disposed on the downstream side of the discharging needle for neutralizing the recording medium thus transported.
Patent Reference: Japanese Patent Publication No. 2009-236999

In the conventional image forming apparatus disclosed in Patent Reference, it is difficult to obtain an image with high quality.

In view of the problems described above, an object of the present invention is to provide an image forming apparatus capable of obtaining an image with high quality.

Further objects and advantages of the invention will be apparent from the following description of the invention.

### SUMMARY OF THE INVENTION

In order to attain the objects described above, according to an aspect of the present invention, an image forming apparatus includes an image forming unit having an image supporting member for supporting a developer image; a transfer device for transferring the developer image on the image supporting member to a front surface of a recording medium; a neutralizing device disposed on a downstream side of the transfer device in a transportation direction of the recording medium and a side of a backside surface of the recording medium for neutralizing the recording medium with the developer image thus transferred; and a blocking member disposed at a position to face the neutralizing device for blocking the image supporting member from the neutralizing device.

According to the aspect of the present invention, it is possible to obtain an image with high quality.

### BRIEF DESCRIPTION OF THE DRAWINGS

FIG. 1 is an enlarged schematic sectional view showing an image forming unit of an image forming apparatus according to a first embodiment of the present invention;

FIG. 2 is a graph showing a relationship between a protruding amount of a blocking film and a graininess of the image forming apparatus according to the first embodiment of the present invention;

FIG. 3 is a schematic view showing a table of the relationship between the protruding amount of the blocking film and the graininess of the image forming apparatus according to the first embodiment of the present invention;

FIG. 4 is a schematic sectional view showing a configuration of the image forming apparatus according to the first embodiment of the present invention;

FIG. 5 is a schematic sectional view showing a configuration of an image forming portion of the image forming apparatus according to the first embodiment of the present invention;

FIG. 6 is a schematic view showing a photosensitive drum and a transfer roller of the image forming apparatus according to the first embodiment of the present invention;

FIGS. 7(a) to 7(c) are schematic views showing a neutralizing brush of the image forming apparatus according to the first embodiment of the present invention, wherein FIG. 7(a) is a plan schematic view of the neutralizing brush, FIG. 7(b) is a schematic front view of the neutralizing brush, and FIG. 7(c) is a schematic side view of the neutralizing brush;

FIGS. 8(a) to 8(f) are schematic views showing various shapes of the blocking film of the image forming apparatus according to the first embodiment of the present invention;

FIG. 9 is an enlarged schematic sectional view showing an image forming unit of an image forming apparatus according to a second embodiment of the present invention;

FIG. 10 is a graph showing a relationship between a position from a neutralizing brush and a graininess of the image forming apparatus according to the second embodiment of the present invention; and

FIG. 11 is a schematic view showing a table of the relationship between the position from the neutralizing brush and the graininess of the image forming apparatus according to the second embodiment of the present invention.

### DETAILED DESCRIPTION OF PREFERRED EMBODIMENTS

Hereunder, embodiments of the present invention will be explained with reference to the accompanying drawings. It is noted that the drawings are presented for an explanation purpose only, and the present invention is not limited to the drawings.

### First Embodiment

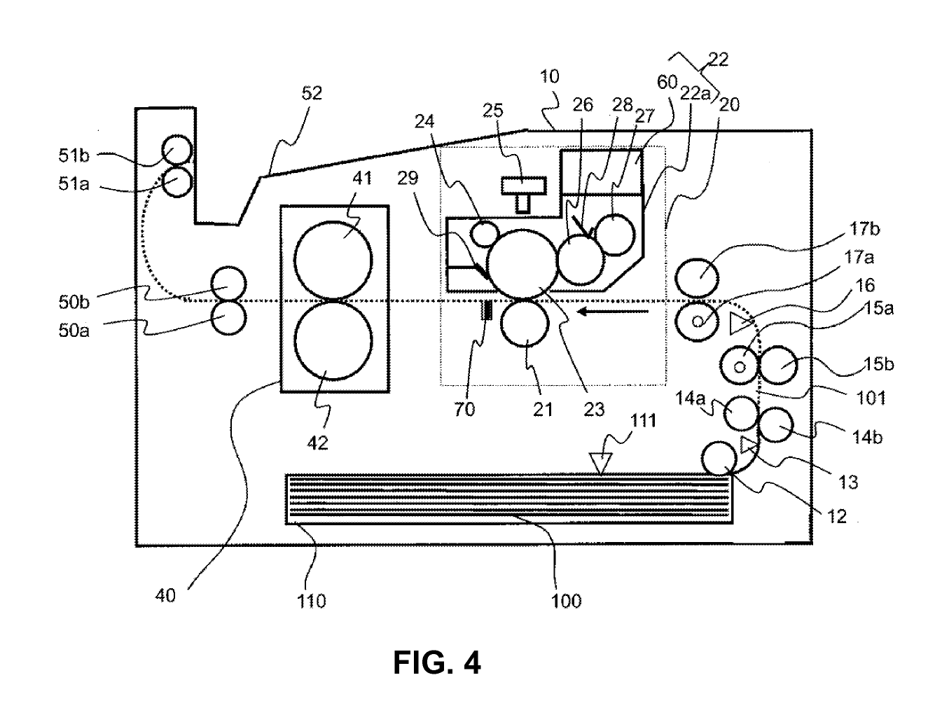

A first embodiment of the present invention will be explained. FIG. 4 is a schematic sectional view showing a configuration of an image forming apparatus 10 according to the first embodiment of the present invention.

As shown in FIG. 4, the image forming apparatus 10 includes a sheet supply portion for supplying a recording medium 100 (for example, a recording sheet); a transportation portion for transporting the recording medium 100; an image forming portion 20 for forming a toner image as a developer image on the recording medium 100; a fixing device 40 for fixing the toner image to the recording medium 100; a sheet discharge portion for discharging the recording medium 100; and a stacker portion 52 for storing the recording medium 100 thus discharged.

Further, the image forming apparatus 10 includes a motor (not shown) for rotating various rollers; a high voltage power source for supplying a high voltage of 200 V to 5,000 V to a charging roller 24, a transfer roller 21, and the like of the image forming portion 20; and a low voltage power source for supplying a direct current voltage of 5V or 24 V to a circuit or a motor.

In the embodiment, a sheet supply cassette 110 is provided as a storage unit for storing the recording medium 100. The fixing device 40 is provided as a fixing unit for supplying heat to the recording medium 100.

In the embodiment, the sheet supply portion includes the sheet supply cassette 110 disposed at a lower portion of the image forming apparatus 10; the recording medium 100 stored in the sheet supply cassette 110; a sheet sensor 111 for detecting whether the recording medium 100 is stored in the sheet supply cassette 110; a pickup roller 12 for picking up and separating the recording medium 100 from the sheet supply cassette 110 one by one using a separation tongue piece and the like; a hop sensor 13 for determining whether the recording medium 100 is being supplied; a sheet supply roller 14a; and a retard roller 14b.

In the embodiment, the sheet supply cassette 110 is configured to store a plurality of recording sheets 100, and disposed detachably at the lower portion of the image forming apparatus 10. The recording sheet 100 is a high quality paper sheet, a recycled paper sheet, a glossy paper sheet; a matte paper sheet, an OHP (over head projector) film, and the like for recording a monochrome image or a color image.

In the embodiment, the pickup roller 12 is arranged to be rotatable and abut against the recording medium 100. The hop sensor 13, the sheet supply roller 14a, and the retard roller 14b are arranged on a downstream side of the pickup roller 12 in a medium transportation path 101 to face each other with the recording medium 100 in between.

In the embodiment, the transportation portion includes a transportation roller 15a, a pinch roller 15b, a writing sensor 16, a register roller 17a, and a pinch roller 17b. The transportation roller 15a and the pinch roller 15b are arranged on a downstream side of the sheet supply roller 14a and the retard roller 14b in the medium transportation path 101 to face each other with the recording medium 100 in between. A motor (not shown) is provided for driving the transportation roller 15a, and the pinch roller 15b follows the transportation roller 15a to rotate.

In the embodiment, the register roller 17a and the pinch roller 17b are arranged on a downstream side of transportation roller 15a and the pinch roller 15b in the medium transportation path 101 to face each other with the recording medium 100 in between. A register motor (not shown) is provided for driving the register roller 17a, and the pinch roller 17b follows the register roller 17a to rotate.

In the embodiment, the image forming portion 20 includes an image forming unit 22; the transfer roller 21; a light source 25 as an exposure unit for irradiating light on a surface of a photosensitive drum 23 according to image information; and a neutralizing brush 70. The image forming unit 22 includes a developer storage unit (a toner cartridge 60) disposed at an upper portion thereof and an image forming unit main body 22a disposed at a lower portion of the image forming portion 20.

In the embodiment, the image forming unit main body 22a includes the photosensitive drum 23 for supporting a static latent image according to the image information; the charging roller 24 as a charging member for charging the photosensitive drum 23; a developing roller 26 as a developing member for developing the static latent image on the surface of the photosensitive drum 23 using toner as developer; a supplying roller 27 as a supplying member for supplying toner to the developing roller 26; a developing blade 28; and a cleaning device 29 for scraping off toner remaining on the photosensitive drum 23. The charging roller 24, the developing roller 26, and the cleaning device 29 are arranged to press against the photosensitive drum 23 with a specific abutting amount. The developing blade 28 and the supplying roller 27 are arranged to press against the developing roller 26 with a specific abutting amount.

In the embodiment, the image forming portion 20 includes a developing unit for developing, for example, the toner image on the recording medium 100.

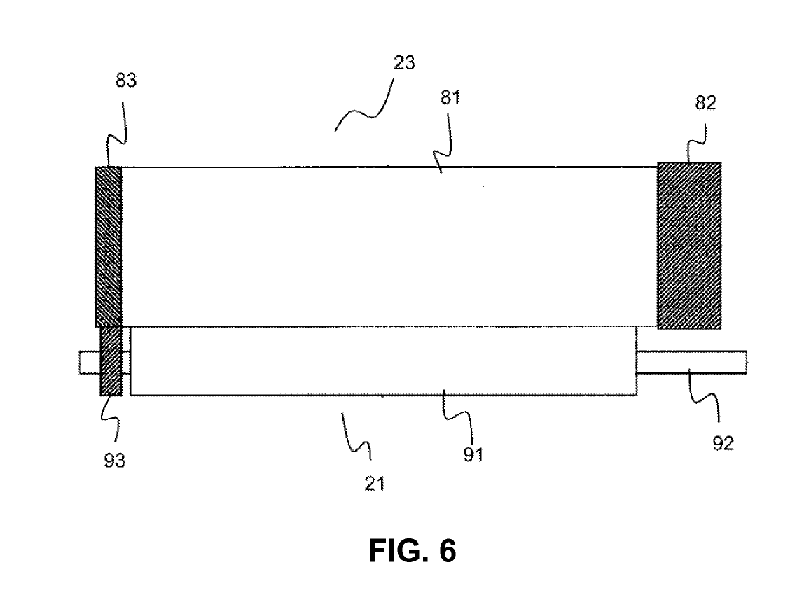

In the embodiment, the photosensitive drum 23 is formed in a circular cylindrical shape, and is supported to be rotatable. The photosensitive drum 23 is formed of a conductive supporting member made of aluminum and the like and a photosensitive layer 81 (refer to FIG. 6, described later) formed on the conductive supporting member. The photosensitive layer 81 is formed of an optical conductive layer and an electron charge transportation layer. The charging roller 24, the transfer roller 21, and the developing roller 26 are arranged to abut against the photosensitive drum 23, and the cleaning device 29 is arranged to abut against the photosensitive drum 23 at a distal end portion thereof. The photosensitive drum 23 is configured to accumulate electron charges on the surface thereof, and functions as the image supporting member for supporting the toner image. Further, the photosensitive drum 23 is arranged to be rotatable in a clockwise direction in FIG. 4.

A configuration of the image forming portion 20 will be explained in more detail in an order of a rotational direction of the photosensitive drum 23. The charging roller 24 is formed in a circular cylindrical shape, and is formed of a conductive metal shaft and a semi-conductive rubber such as silicone covering the conductive metal shaft. The charging roller 24 is supported to be rotatable and abut against the photosensitive drum 23.

In the embodiment, a power source (not shown) is provided for charging the charging roller 24. When the charging roller 24 abuts against the photosensitive drum 23 and rotates, the charging roller 24 applies a specific voltage to the photosensitive drum 23, so that the surface of the charging roller 24 uniformly accumulates electron charges.

In the embodiment, the light source 25 is formed of a plurality of light emitting diodes (referred to as LEDs), a lens array, and an LED drive element. The light source 25 is disposed above the photosensitive drum 23. The light source 25 is provided for irradiating light on the surface of the photosensitive drum 23 according to the image information, so that the static latent image is formed on the surface of the photosensitive drum 23.

In the embodiment, the supplying roller 27 is formed in a circular cylindrical shape, and is formed of a conductive metal shaft and a layer covering the conductive metal shaft. The supplying roller 27 is supported to abut against the developing roller 26. A power source (not shown) is provided for applying a voltage to the supplying roller 27, so that the supplying roller 27 supplies toner to the developing roller 26 while abutting against the developing roller 26.

In the embodiment, the developing roller 26 is formed in a circular cylindrical shape, and is formed of a conductive metal shaft and a semi-conductive urethane rubber covering the conductive metal shaft. The developing roller 26 is arranged to abut against the photosensitive drum 23 and the supplying roller 27 and contact with a distal end portion of the developing blade 28. A power source (not shown) is provided for applying a voltage to the developing roller 26, so that toner is attached to the static latent image formed on the surface of the charging roller 24 to develop the static latent image, thereby forming the toner image.

In the embodiment, the developing blade 28 as a developer layer regulating member is made of stainless steel and the like, and is formed in a plate shape. Further, the developing blade 28 is arranged such that the distal end portion thereof contacts with a surface of the developing roller 26. The developing blade 28 is provided for scraping off toner exceeding a specific amount on the surface of the developing roller 26, so that the developing blade 28 regulates a thickness of a toner layer on the surface of the developing roller 26 at a constant level.

In the embodiment, the cleaning device 29 as a cleaning member is formed of a rubber material and the like, and is formed in a plate shape. Further, the cleaning device 29 is arranged such that the distal end portion thereof contacts with the surface of the photosensitive drum 23. After the toner image formed on the photosensitive drum 23 is transferred to the recording medium 100, the cleaning device 29 scrapes off toner remaining on the photosensitive drum 23, thereby cleaning the photosensitive drum 23.

In the embodiment, a power source (not shown) is provided for applying a voltage of −1.0 kV to −1.5 kV to the neutralizing brush 70 when the image forming apparatus 10 performs a printing operation, so that the neutralizing brush 70 neutralizes the recording medium 100.

In the embodiment, the fixing device 40 includes a fixing roller 41 and a backup roller 42. The fixing device 40 is provided as a fixing unit for pressing and heating the recording medium 100, so that the toner image is fixed to the recording medium 100.

In the embodiment, the image forming apparatus 10 further includes a discharging portion having discharging rollers 50a and 50b and discharging rollers 51a and 51b. The discharging rollers 50a and 50b and the discharging rollers 51a and 51b are disposed on a downstream side of the fixing device 40 in the medium transportation path 101 to face each other with the recording medium 100 in between. A motor (not shown) is provided for driving the discharging rollers 50a and 50b and the discharging rollers 51a and 51b.

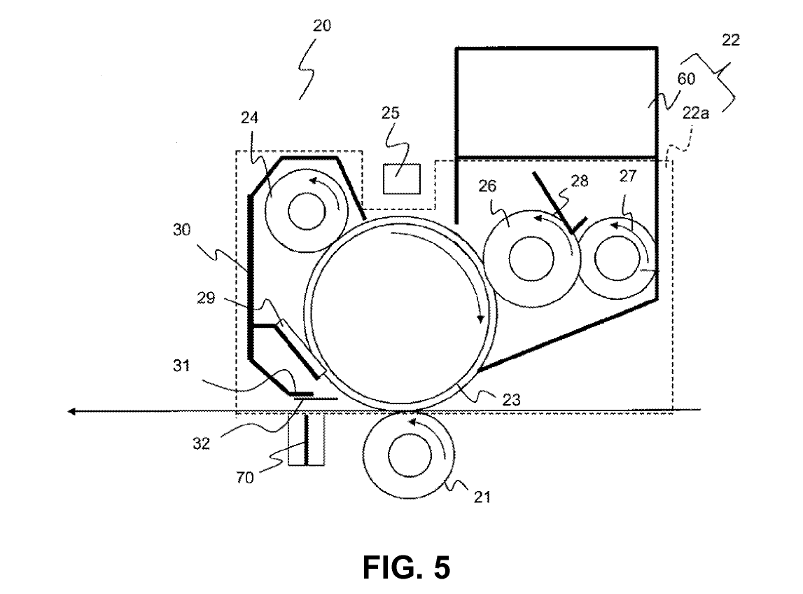

The configuration of the image forming portion 20 shown in FIG. 4 will be explained in more detail with reference to FIG. 5. FIG. 5 is a schematic sectional view showing the configuration of the image forming portion 20 of the image forming apparatus 10 according to the first embodiment of the present invention.

As shown in FIG. 5, the image forming portion 20 includes the image forming unit 22; the transfer roller 21; the light source 25 as the exposure unit attached to the image forming unit main body 22a for irradiating light on the surface of the photosensitive drum 23 according to the image information; and the neutralizing brush 70. Further, the image forming unit 22 includes the toner cartridge 60 disposed at the upper portion thereof and the image forming unit main body 22a disposed at the lower portion of the image forming portion 20.

In the embodiment, the image forming unit main body 22a is covered with a mold 30, and an entire portion of the mold 30 is formed of a resin. The mold 30 is provided as a frame member for supporting the photosensitive drum 23, the charging roller 24, and the cleaning device 29.

In the embodiment, the mold 30 further supports the developing roller 26, the supplying roller 27, and the developing blade 28. A blocking film 32 as a blocking member is disposed on a bottom surface portion 31 of the mold 30 situated below the cleaning device 29. Further, the neutralizing brush 70 is disposed below the bottom surface portion 31, so that the medium transportation path 101 is situated between the blocking film 32 and the neutralizing brush 70.

In the embodiment, the image forming unit main body 22a includes the photosensitive drum 23, the charging roller 24, the developing roller 26, the supplying roller 27, the developing blade 28, and the cleaning device 29 in the mold 30.

In the embodiment, the photosensitive drum 23 is configured to rotate through a drive of a motor (not shown). The photosensitive drum 23 is provided as the image supporting member for accumulating electron charges on the surface thereof, so that the static latent image is formed on the surface upon removing electron charges through exposing light thereon.

In the embodiment, the charging roller 24 is arranged to contact with the surface of the photosensitive drum 23 with a specific pressure, and rotate in the same direction, so that the charging roller 24 applies a specific potential to the surface of the photosensitive drum 23.

In the embodiment, the light source 25 is disposed above the photosensitive drum 23 for removing electron charges accumulated with the charging roller 24, so that the static latent image is formed on the photosensitive drum 23.

In the embodiment, the toner cartridge 60 is disposed at the upper portion of the image forming portion 20 for retaining toner, so that toner is supplied through a supply opening formed in a lower portion of the toner cartridge 60 to the image forming unit main body 22a.

In the embodiment, the image forming unit main body 22a further includes the developing roller 26 for developing toner supplied from the toner cartridge 60 to the photosensitive drum 23; the supplying roller 27 for supplying toner to the developing roller 26; and the developing blade 28 for regulating toner on the developing roller 26 at a specific thickness. The developing roller 26 is arranged to contact with the photosensitive drum 23 with a specific pressure. The transfer roller 21 is provided as a transfer member below the photosensitive drum 23. The photosensitive drum 23 and the transfer roller 21 are arranged to sandwich and transport the recording medium 100, so that the toner image is formed on the surface of the recording medium 100.

FIG. 6 is a schematic view showing the photosensitive drum 23 and the transfer roller 21 of the image forming apparatus 10 shown in FIG. 5 according to the first embodiment of the present invention.

As shown in FIG. 6, the photosensitive drum 23 includes the conductive supporting member formed in a circular cylindrical shape and the photosensitive layer 81 formed on the conductive supporting member. A photosensitive drum gear 82 and a photosensitive drum gear 83 are disposed on edge surfaces of the conductive supporting member with the circular cylindrical shape. The conductive supporting member is made of an aluminum alloy, and has a thickness of 0.74 mm and an outer diameter of 30 mm. The photosensitive layer 81 has a thickness of 18 μm. The photosensitive drum 23 is provided as the image supporting member for supporting the developer image.

In the embodiment, the transfer roller 21 includes a metal shaft 92 formed in a circular cylindrical shape and a foamed elastic layer 91 with semi-conductivity formed on a circumferential surface of the metal shaft 92. A transfer roller gear 93 is disposed on an edge portion of the metal shaft 92. The metal shaft 92 has an outer diameter of 6 mm. The foamed elastic layer 91 is made of an epichlorohydrin rubber, and has an outer diameter of 16 mm. The transfer roller 21 is provided as the transfer member for transferring the developer image on the photosensitive drum 23 to the surface of the recording medium 100.

In the embodiment, the photosensitive drum 23 is arranged to press against the transfer roller 21 with a pushing amount of 0.3 to 0.4 mm. The transfer roller gear 93 is arranged to engage with the photosensitive drum gear 83. When the photosensitive drum 23 rotates, the photosensitive drum gear 83 follows and rotates to transmit the rotational force to the transfer roller gear 93, so that the transfer roller 21 rotates. A transfer power source (not shown) is provided for applying a voltage to the transfer roller 21.

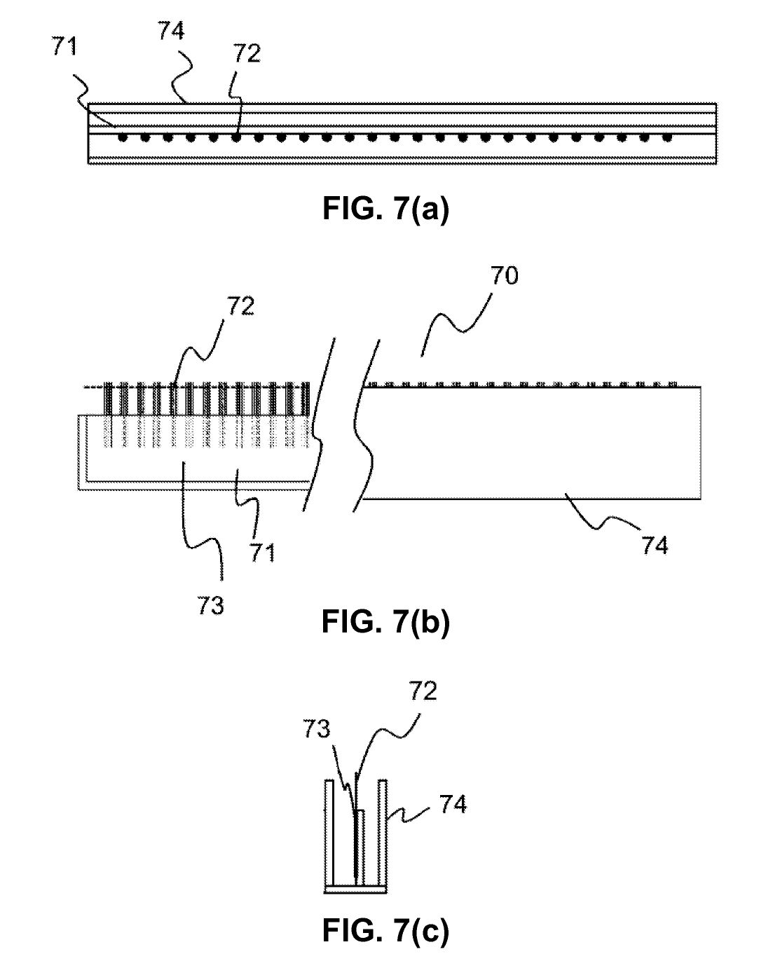

A configuration of the neutralizing brush 70 will be explained next with reference to FIG. 7. FIGS. 7(a) to 7(c) are schematic views showing the neutralizing brush 70 of the image forming apparatus 10 according to the first embodiment of the present invention. More specifically, FIG. 7(a) is a plan schematic view of the neutralizing brush 70; FIG. 7(b) is a schematic front view of the neutralizing brush 70; and FIG. 7(c) is a schematic side view of the neutralizing brush 70. FIG. 7(b) shows a blocking wall 74 on a right side thereof and an internal configuration on a left side of the blocking wall 74.

As shown in FIGS. 7(a) to 7(c), the neutralizing brush 70 includes a thin plate 71 made of aluminum; a plurality of linear members 72 made of a stainless steel fiber; a conductive adhesive tape 73; and the blocking wall 74 having a recessed shape.

In the embodiment, the linear members 72 are fixed to the thin plate 71 with the conductive adhesive tape 73, so that the linear members 72 protrude beyond an upper edge portion of the thin plate 71. The linear members 72 are formed of bundles of about a dozen of the stainless steel fibers, and the bundles are arranged with an interval of 1 mm. The blocking wall 74 having the recessed shape is attached to a lower portion of the thin plate 71, so that the blocking wall 74 blocks the thin plate 71 and the linear members 72 in a front-to-rear direction.

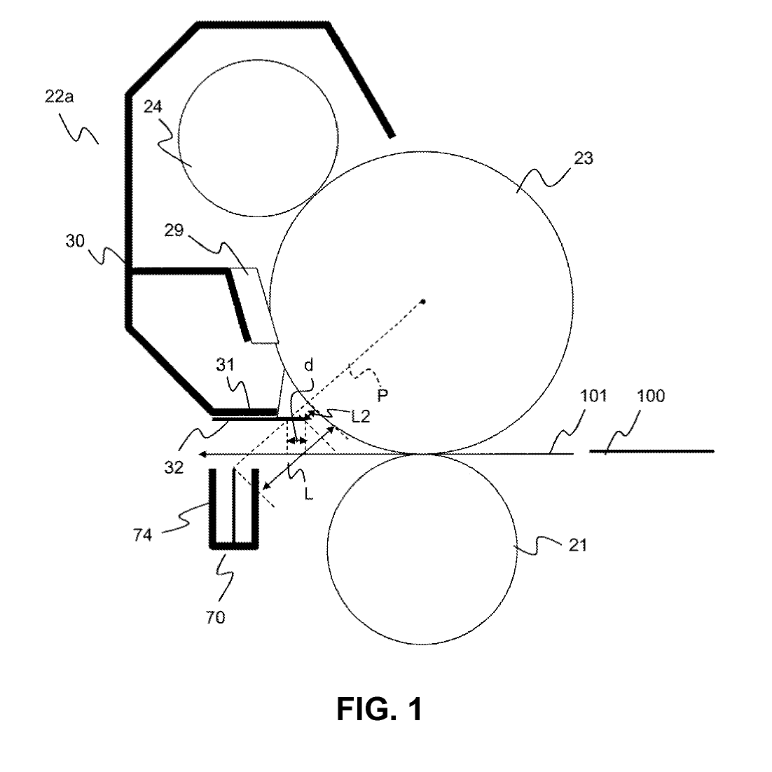

An arrangement of the neutralizing brush 70 in the image forming unit 22 will be explained next. FIG. 1 is an enlarged schematic sectional view showing the image forming unit 22 of the image forming apparatus 10 according to the first embodiment of the present invention.

As shown in FIG. 1, the mold 30 made of a resin covers the entire portion of the image forming unit main body 22a. Further, the photosensitive drum 23, the charging roller 24, and the cleaning device 29 are disposed inside the image forming unit main body 22a.

In the embodiment, the blocking film 32 is attached with a double side adhesive tape to the bottom surface portion 31 of the mold 30 situated below the cleaning device 29. The blocking film 32 is formed of a resin film such as a polyethylene terephthalate member (referred to as a PET member), and has a thickness of 0.1 mm. The blocking film 32 is arranged to face the neutralizing brush 70 on an opposite side of the medium transportation path 101, so that the blocking film 32 blocks between the photosensitive drum 23 and the neutralizing brush 70.

In the embodiment, the blocking film 32 is situated away from the photosensitive drum 23 by a distance L2 in a range of 0.5 mm to 2.0 mm, so that the blocking film 32 does not scrape off toner on the photosensitive drum 23.

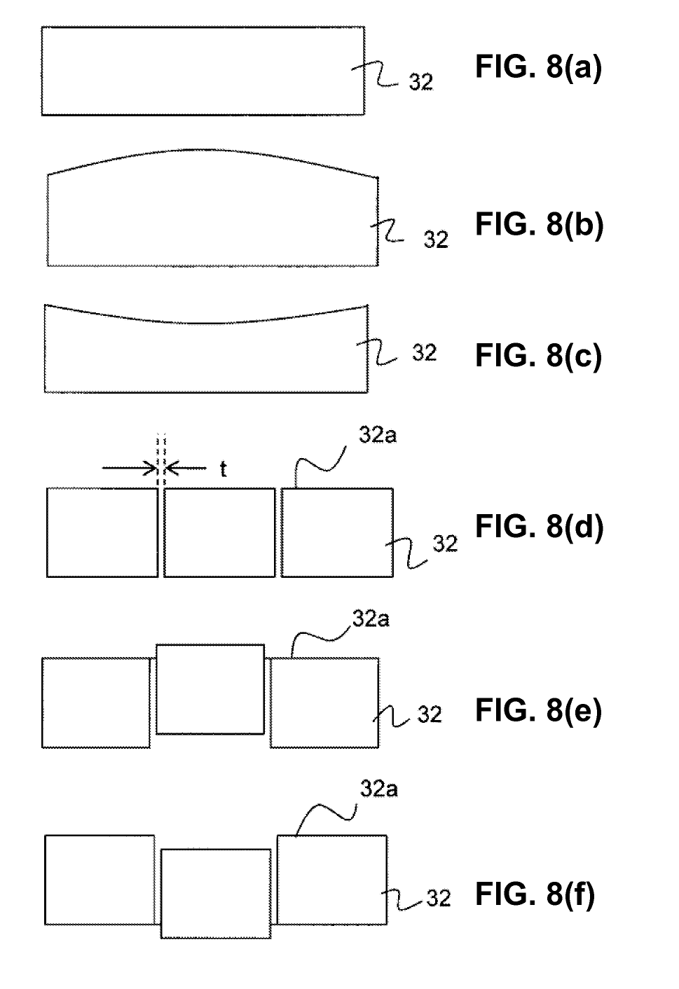

A shape of the blocking film 32 will be explained next with reference to FIGS. 8(a) to 8(f). FIGS. 8(a) to 8(f) are schematic views showing various shapes of the blocking film 32 of the image forming apparatus 10 according to the first embodiment of the present invention.

As shown in FIG. 8(a), the blocking film 32 is formed in a rectangular shape. The shape of the blocking film 32 is not limited thereto, and the blocking film 32 may be formed in a convex shape as shown in FIG. 8(b) and may be formed in a concave shape as shown in FIG. 8(c).

For example, when the image forming portion 20 is assembled, if a center portion of the mold 30 deforms in a direction away from the photosensitive drum 23, the blocking film 32 is formed in the convex shape shown in FIG. 8(b). In this case, the blocking film 32 protrudes toward the photosensitive drum 23 at the center portion of the mold 30. Accordingly, even when the center portion of the mold 30 deforms in the direction away from the photosensitive drum 23, and the center portion of the mold 30 separates away from the photosensitive drum 23, a large space is not generated between the blocking film 32 and the photosensitive drum 23. As a result, it is possible to securely block between the photosensitive drum 23 and the neutralizing brush 70 with the blocking film 32.

On the other hand, when the image forming portion 20 is assembled, if the center portion of the mold 30 deforms in a direction closer to the photosensitive drum 23, the blocking film 32 is formed in the concave shape shown in FIG. 8(c). In this case, the blocking film 32 is concaved at the center portion of the mold 30.

Accordingly, as opposed to the convex shape shown in FIG. 8(b), even when the center portion of the mold 30 deforms in the direction closer the photosensitive drum 23, and the center portion of the mold 30 approaches toward the photosensitive drum 23, the center portion of the mold 30 does not contact with the photosensitive drum 23. As a result, it is possible to securely block between the photosensitive drum 23 and the neutralizing brush 70 with the blocking film 32 without contacting with the photosensitive drum 23.

Further, the blocking film 32 may not be formed of the single film, and may be formed in a divided shape as shown in FIGS. 8(d) to 8(f). It should be noted that divided portions of the blocking film 32 in FIGS. 8(d) to 8(f) are arranged in a divided pattern with an interval t equal to or smaller than 1 mm. As shown in FIG. 8(d), the blocking film 32 may have a front edge portion 32a.

When the image forming portion 20 is assembled, if the center portion of the mold 30 deforms in the direction away from the photosensitive drum 23, the blocking film 32 is formed in the shape shown in FIG. 8(e). In this case, the front edge portion 32a of the center portion of the blocking film 32 protrudes toward the photosensitive drum 23. Accordingly, even when the center portion of the mold 30 deforms in the direction away from the photosensitive drum 23, and the center portion of the mold 30 separates away from the photosensitive drum 23, similar to the convex shape shown in FIG. 8(b), it is possible to securely block between the photosensitive drum 23 and the neutralizing brush 70 with the blocking film 32.

On the other hand, when the image forming portion 20 is assembled, if the center portion of the mold 30 deforms in the direction closer to the photosensitive drum 23, the blocking film 32 is formed in the shape shown in FIG. 8(f). In this case, the front edge portion 32a of the center portion of the blocking film 32 is away from the photosensitive drum 23.

Accordingly, as opposed to the case shown in FIG. 8(e), even when the center portion of the mold 30 deforms in the direction closer the photosensitive drum 23, and the center portion of the mold 30 approaches toward the photosensitive drum 23, similar to the concave shape shown in FIG. 8(c), it is possible to securely block between the photosensitive drum 23 and the neutralizing brush 70 with the blocking film 32 without contacting with the photosensitive drum 23.

As shown in FIG. 1, a line P connects between a distal end portion of the linear members 72 of the neutralizing brush 70 and a center point of the photosensitive drum 23. Further, a minimum distance L is defined between the distal end portion of the linear members 72 and the surface of the photosensitive drum 23. In this case, the blocking film 32 is arranged to cross the line P and protrude by a protruding amount d toward the photosensitive drum 23.

In the embodiment, the neutralizing brush 70 is situated away from the surface of the photosensitive drum 23 by the distance L, and the blocking film 32 is situated away from the surface of the photosensitive drum 23 by the distance L2. Further, the blocking film 32 is arranged to cross the line P between the linear members 72 of the neutralizing brush 70 and the center point of the photosensitive drum 23.

The printing operation of the image forming apparatus 10 will be explained next with reference to FIG. 4. First, the recording medium 100 is transported along the medium transportation path 101 from the upstream side to the downstream side. The sheet supply cassette 110 is disposed on the most upstream side, and the stacker portion 52 is disposed on the most downstream side.

In the embodiment, the image forming apparatus 10 is connected to a host device through a cable or wireless. When the image forming apparatus 10 receives a print instruction from the host device, and the print data is transmitted to the image forming apparatus 10, a pickup motor (not shown) rotates the pickup roller 12 to separate the recording medium 100 one by one, so that the recording medium 100 is transported toward the downstream side of the medium transportation path 101.

While transporting the medium transportation path 101, the hop sensor 13 detects whether the pickup roller 12 properly supplies the recording medium 100. When the hop sensor 13 detects that the pickup roller 12 does not properly supply the recording medium 100, the sheet supply operation is repeated. At the same time when the sheet supply operation starts, the image forming portion 20 starts rotating the rollers, so that the photosensitive drum 23 rotates at least one revolution until the recording medium 100 reaches the photosensitive drum 23.

In the embodiment, when a motor (not shown) rotates the sheet supply roller 14a, the retard roller 14b follows the sheet supply roller 14a to rotate. Accordingly, the recording medium 100 transported from the pickup roller 12 is sandwiched between the sheet supply roller 14a and the retard roller 14b, so that the recording medium 100 is transported to the transportation roller 15a and the pinch roller 15b disposed on the downstream side of the medium transportation path 101.

As described above, the pickup roller 12 and the sheet supply roller 14a separate and transport the recording medium 100 one by one. Accordingly, when the recording medium 100 reaches the transportation roller 15a and the pinch roller 15b, the recording medium 100 may be skewed. To this end, it is configured such that the recording medium 100 abuts against the transportation roller 15a and the pinch roller 15b that are not rotating, thereby removing the skew. After the recording medium 100 abuts against the transportation roller 15a and the pinch roller 15b, a clutch is connected to transmit the drive force, so that the transportation roller 15a starts rotating.

Afterward, the transportation roller 15a and the pinch roller 15b transport the recording medium 100, so that the writing sensor 16 is turned on. After a specific period of time after the writing sensor 16 is turned on, the light source 25 starts exposing the photosensitive drum 23, so that the static latent image is formed on the photosensitive drum 23.

In the next step, when the register motor (not shown) drives the register roller 17a to rotate, the pinch roller 17b follows the register roller 17a to rotate. Accordingly, the register roller 17a and the pinch roller 17b transport the recording medium 100 to the image forming portion 20 on the downstream side of the medium transportation path 101.

In the embodiment, the photosensitive drum 23 of the image forming portion 20 rotates in the clockwise direction in FIG. 4, and the charging roller 24 uniformly charges the surface of the photosensitive drum 23 first. After the surface of the photosensitive drum 23 is uniformly charged, the light source 25 irradiates light on the photosensitive drum 23 according to the image information received from the host device, so that the static latent image is formed on the photosensitive drum 23.

After the static latent image is formed on the photosensitive drum 23, the developing roller 26 and the supplying roller 27 develops the static latent image to form the toner image. After the static latent image is developed, the photosensitive drum 23 and the transfer roller 21 sandwich and transport the recording medium 100. At this moment, a voltage of +1,000 V to +3,000 V is applied to the transfer roller 21. Accordingly, toner on the photosensitive drum 23 is attracted toward the recording medium 100, so that the toner image is transferred to the recording medium 100. After the toner image is transferred to the recording medium 100, the transfer roller 21 charges the recording medium 100 with the positive polarity.

After the transfer roller 21 charges the recording medium 100 with the positive polarity, the neutralizing brush 70 neutralizes the recording medium 100. Afterward, the recording medium 100 is transported to the fixing device 40, so that the toner image is fixed to the recording medium 100. The cleaning device 29 scrapes off toner remaining on the photosensitive drum 23, and a collecting mechanism (not shown) collects toner in a waste toner storage portion of the toner cartridge 60.

After the toner image is transferred to the recording medium 100, the recording medium 100 is sandwiched and transported in the nip region formed between the fixing roller 41 and the backup roller 42 in the fixing device 40. More specifically, the recording medium 100 is heated with the fixing roller 41 and pressed with the backup roller 42 in the nip region, so that toner is melted to fix the toner image.

After the toner image is fixed to the recording medium 100, the discharging roller 50a and 50b and the discharging roller 51a and 51b rotate to transport the recording medium 100, so that the recording medium 100 is discharged on the stacker portion 52.

An operation of the image forming portion 20 will be explained in more detail with reference to FIG. 5. A drive portion (not shown) is provided for driving the photosensitive drum 23 through the photosensitive drum gear 82, so that the photosensitive drum 23 rotates in the clockwise direction. The charging roller 24 follows the photosensitive drum 23 to rotate, so that the charging roller 24 charges the surface of the photosensitive drum 23 with the negative polarity. After the surface of the photosensitive drum 23 is charged with the negative polarity, the light source 25 irradiates light on the photosensitive drum 23 to remove electron charges in an image portion, so that the static latent image is formed on the photosensitive drum 23.

In the embodiment, the toner cartridge 60 is disposed above the image forming unit main body 22a, so that toner is supplied inside the image forming unit main body 22a. After toner is supplied inside the image forming unit main body 22a, the supplying roller 27 supplies toner to the developing roller 26.

In the embodiment, the developing roller 26 and the supplying roller 27 rotate in the counterclockwise direction at a specific circumferential speed ratio through the drive from the photosensitive drum 23. When the developing roller 26 and the supplying roller 27 rotate in the counterclockwise direction, toner is charged with the negative polarity, and toner is transported from the supplying roller 27 to the developing roller 26.

In the embodiment, the developing blade 28 regulates the toner layer on the developing roller 26 at a constant level, so that the toner layer on the developing roller 26 develops the static latent image on the photosensitive drum 23. The transfer roller 21 follows the rotation of the photosensitive drum 23 to rotate through the engagement between the transfer roller gear 93 and the photosensitive drum gear 83.

After the static latent image is developed with toner, the transfer roller 21 transfers the toner image from the surface of the photosensitive drum 23 to the recording medium 100, so that the toner image is formed on the recording medium 100. The cleaning device 29 scrapes off toner not transferred to the recording medium 100 and remaining on the photosensitive drum 23, thereby completing the printing operation.

In the embodiment, if the voltage is applied to the photosensitive drum 23 without the recording medium 100, the photosensitive drum 23 may be damaged. Accordingly, it is controlled such that the voltage is applied to the photosensitive drum 23 when the toner image is transferred from the photosensitive drum 23 to the recording medium 100. Further, synchronizing with the timing of the recording medium 100 reaching the photosensitive drum 23, it is controlled such that the voltage with the positive polarity is applied to the transfer roller 21 from the transfer power source, and the voltage with the negative polarity is applied to the neutralizing brush 70 from a neutralization power source. Further, synchronizing with the timing of the recording medium 100 separating from the photosensitive drum 23, it is controlled such that the voltage with the positive polarity applied to the transfer roller 21 is terminated, and the voltage with the negative polarity applied to the neutralizing brush 70 is terminated.

In the embodiment, when the recording medium 100 reaches the photosensitive drum 23, the recording medium 100 is charged with the positive polarity through the voltage applied to the transfer roller 21. After the recording medium 100 is charged with the positive polarity, the recording medium 100 is attracted toward the photosensitive drum 23 through a coulombic force generated by the electric field between the photosensitive drum 23 and the transfer roller 21. At this time, the voltage with the negative polarity is applied to the neutralizing brush 70 to neutralize the recording medium 100 charged with the positive polarity, so that the recording medium 100 is not adhered to the photosensitive drum 23.

In the embodiment, when the voltage with the negative polarity is applied to the neutralizing brush 70, the photosensitive drum 23 blocks the electric field between the photosensitive drum 23 and the neutralizing brush 70, thereby restricting the photosensitive drum 23 to be charged with the negative polarity. If the blocking film 32 has an insufficient length, the neutralizing brush 70 may over charge the photosensitive drum 23, thereby excessively increasing the surface potential of the photosensitive drum 23 locally. When the surface potential of the photosensitive drum 23 is increased locally, an area with the high potential tends to have a low print density, thereby causing density variance.

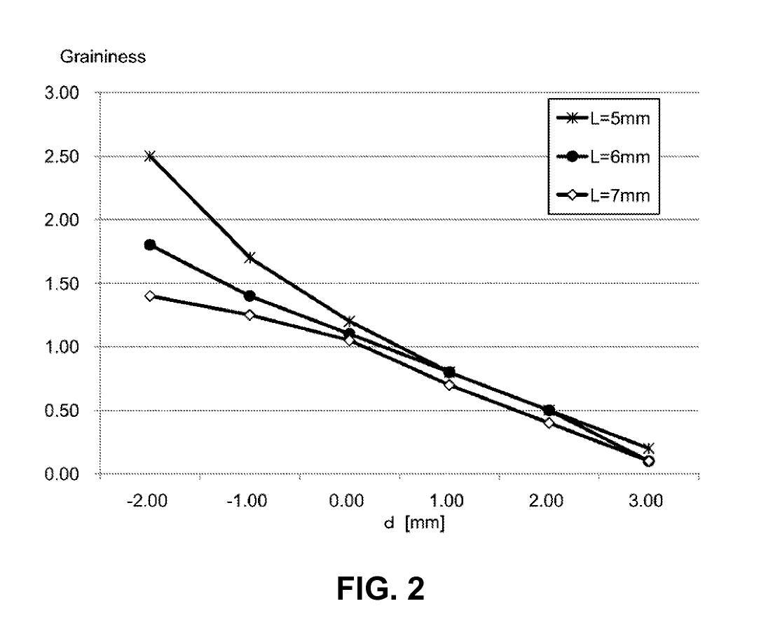

An experiment was conducted for evaluating the length of the blocking film 32 and the density variance. FIG. 2 is a graph showing a relationship between a protruding amount d of the blocking film 32 and a graininess of the image forming apparatus 10 according to the first embodiment of the present invention. In FIG. 2, the vertical axis represents the protruding amount d of the blocking film 32, and the horizontal axis represents a graininess value. Measurement points are plotted when the distance was changed from 5 mm to 7 mm.

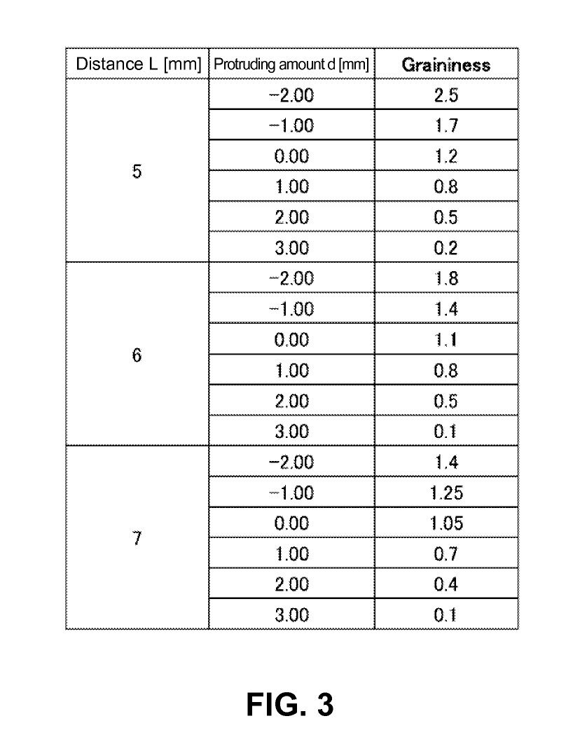

FIG. 3 is a schematic view showing a table of the relationship between the protruding amount d of the blocking film 32 and the graininess of the image forming apparatus according to the first embodiment of the present invention.

In the experiment, when the density variance was measured in the printing operation, an entire uniform pattern with the print density 100% duty was printed on the recording medium 100 having the A4 size. Then, the graininess value was measured at nine locations on the recording medium 100 thus printed, three locations in the vertical direction and three locations in the lateral direction, thereby obtaining the density variance. The measurement was conducted with Pias II (a product of Quality Engineering Associate (QEA), Inc.).

In the experiment, when the graininess value was less than 1.0, it was determined that the density variance was good. When the graininess value was equal to or greater than 1.0, it was determined that the density variance was poor.

As shown in FIGS. 2 and 3, when the protruding amount d of the blocking film 32 was a positive value, regardless of the distance L from the neutralizing brush 70 to the photosensitive drum 23, the graininess value was maintained less than 1.0. Accordingly, when the protruding amount d of the blocking film 32 is increased, it is possible to obtain an image with high quality.

However, when the blocking film 32 is arranged too close to the photosensitive drum 23, the blocking film 32 may scrape off toner not transferred and remaining on the photosensitive drum 23. Accordingly, it is preferred that the distance L2 between the photosensitive drum 23 and the blocking film 32 is between 0.5 mm and 2.0 mm.

As described above, in the embodiment, it is possible to obtain the following effects. In the embodiment, the blocking film 32 is arranged to cross the line P connecting between the center point of the photosensitive drum 23 and the distal end portion of the neutralizing brush 70. Accordingly, in addition to the effect of the neutralizing brush 70 for neutralizing the recording medium 100 charged with the positive polarity so that the recording medium 100 is not wound around the photosensitive drum 23, it is possible with the blocking film 32 to prevent the neutralizing brush 70 from charging the photosensitive drum 23 with the negative polarity, thereby forming an image with high quality without excessive density variance.

In the embodiment, when the center portion of the mold 30 separates away from the photosensitive drum 23, the blocking film 32 is formed in the convex shape shown in FIG. 8(b). Accordingly, even when the center portion of the mold 30 separates away from the photosensitive drum 23, a large space is not generated between the blocking film 32 and the photosensitive drum 23. As a result, it is possible to securely block between the photosensitive drum 23 and the neutralizing brush 70 with the blocking film 32.

On the other hand, when the center portion of the mold 30 approaches toward the photosensitive drum 23, the blocking film 32 is formed in the concave shape shown in FIG. 8(c). In this case, the blocking film 32 is concaved at the center portion of the mold 30. Accordingly, even when the center portion of the mold 30 approaches toward the photosensitive drum 23, the center portion of the mold 30 does not contact with the photosensitive drum 23. As a result, it is possible to securely block between the photosensitive drum 23 and the neutralizing brush 70 with the blocking film 32 without contacting with the photosensitive drum 23.

### Second Embodiment

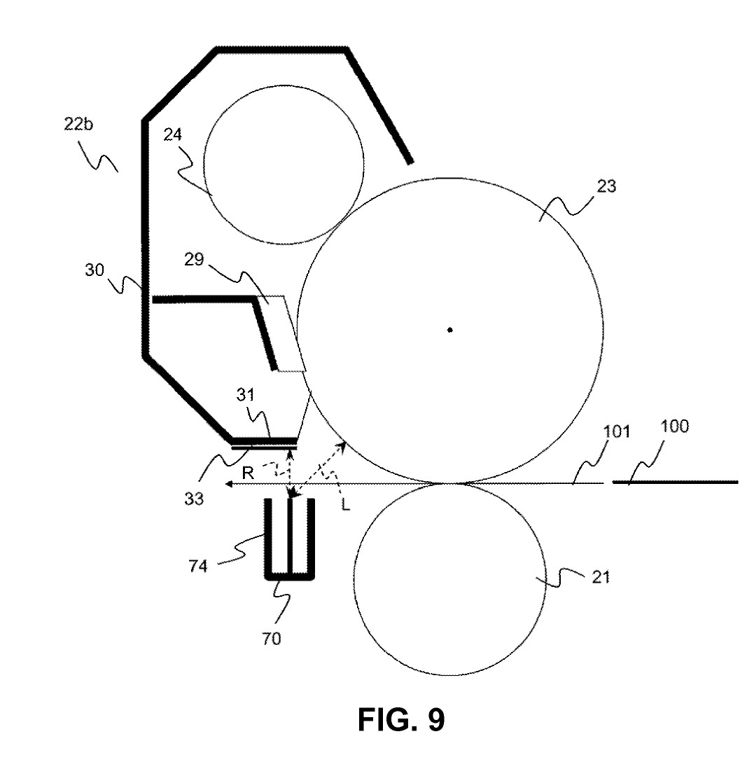

A second embodiment of the present invention will be explained next with reference to FIG. 9. FIG. 9 is an enlarged schematic sectional view showing the image forming unit 22 of the image forming apparatus 10 according to the second embodiment of the present invention. Components in the second embodiment similar to those in the first embodiment shown in FIG. 1 are designated with the same reference numerals.

In the second embodiment, similar to the image forming unit main body 22a, an image forming unit main body 22b is covered with the mold 30, an entire portion of which is formed of a resin. Further, the photosensitive drum 23, the charging roller 24, and the cleaning device 29 are disposed in the image forming unit main body 22b.

In the second embodiment, different from the first embodiment, a conductive film 33 as a conductive member is attached to the bottom surface portion 31 of the mold 30 situated below the cleaning device 29. The conductive file 33 is connected to ground through a conductive path (not shown). The conductive film 33 is formed of a PET member formed in a film shape and a fluorine resin conductive tape attached to a surface of the PET member. The conductive film 33 is arranged to face the neutralizing brush 70 on the opposite side of the medium transportation path 101, and is connected to ground.

As shown in FIG. 9, the conductive film 33 is disposed away from the distal end portion of the linear members 72 of the neutralizing brush 70 by a distance R. The image forming unit main body 22b is configured such that the distance L and the distance R establish the following relationship:

1<L/R≦1.4

In other words, the image forming unit main body 22b is configured such that the distance L between the neutralizing brush 70 and the photosensitive drum 23 is greater than the distance R between the neutralizing brush 70 and the conductive film 33, or that the distance L between the neutralizing brush 70 and the photosensitive drum 23 is equal to or smaller than 1.4 times of the distance R between the neutralizing brush 70 and the conductive film 33.

In the second embodiment, the image forming portion 20 includes the image forming unit main body 22b different from the image forming unit main body 22a in the first embodiment. Other components of the image forming portion 20 are similar to those in the first embodiment. Further, the printing operation of the image forming portion 20 is similar to that in the first embodiment, and an explanation thereof is omitted.

In the second embodiment, a control unit (not show) is provided for controlling each power source to apply a voltage to each component of the image forming unit main body 22b at a specific timing. Further, synchronizing with the timing of the recording medium 100 reaching the photosensitive drum 23, the control unit controls the transfer power source to apply the voltage with the positive polarity to the transfer roller 21, and controls the neutralization power source to apply the voltage with the negative polarity to the neutralizing brush 70.

In the second embodiment, when the voltage with the negative polarity is applied to the neutralizing brush 70, the electric filed is generated between the neutralizing brush 70 and the photosensitive drum 23, and between the neutralizing brush 70 and the conductive film 33. Accordingly, the electric fields neutralize the recording medium 100 charged with the positive polarity, so that the recording medium 100 is not adhered to the photosensitive drum 23. Further, synchronizing with the timing of the recording medium 100 separating from the photosensitive drum 23, the control unit controls the transfer power source to stop applying the voltage with the positive polarity to the transfer roller 21, and controls the neutralization power source to stop applying the voltage with the negative polarity to the neutralizing brush 70.

In the second embodiment, as described above, the image forming unit main body 22b is configured such that the distance L between the neutralizing brush 70 and the photosensitive drum 23 is greater than the distance R between the neutralizing brush 70 and the conductive film 33. Accordingly, it is possible to prevent the photosensitive drum 23 from being excessively neutralized.

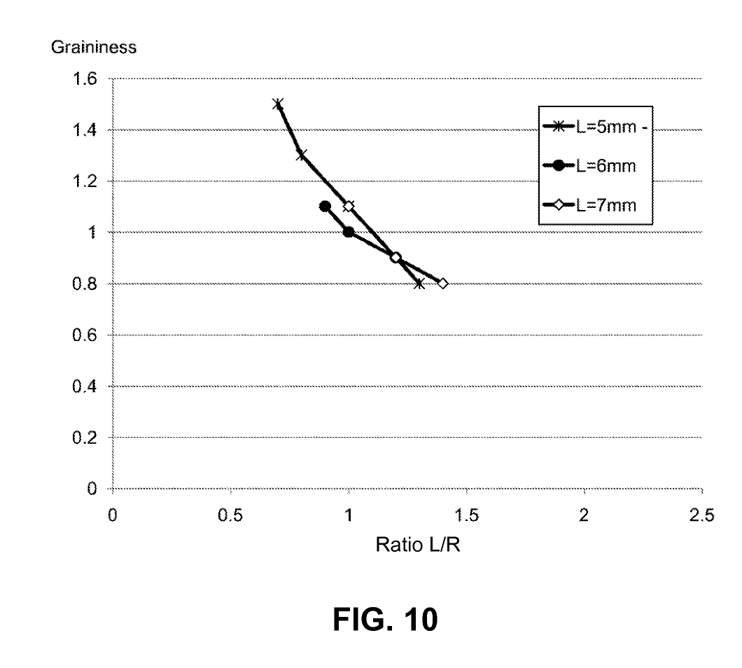

An experiment was conducted for evaluating the ratio between the distance L and the distance R and the density variance. FIG. 10 is a graph showing a relationship between a position from the neutralizing brush 70 and the graininess of the image forming apparatus 10 according to the second embodiment of the present invention. In FIG. 10, the vertical axis represents the ratio between the distance L and the distance R (L/R), and the horizontal axis represents a graininess value. Measurement points are plotted when the distance L was changed from 5 mm to 7 mm.

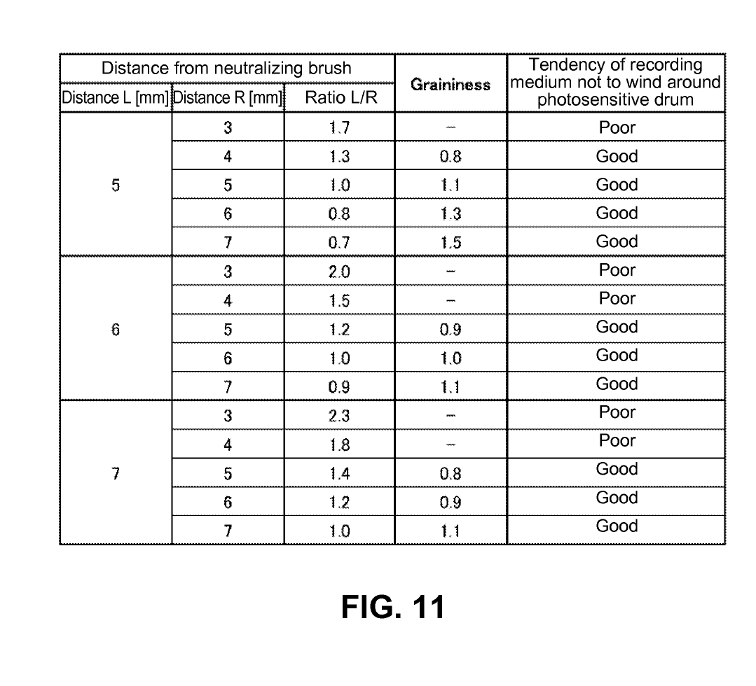

FIG. 11 is a schematic view showing a table of the relationship between the position from the neutralizing brush 70 and the graininess of the image forming apparatus 10 according to the second embodiment of the present invention.

In the experiment, in changing the ratio L/R, the distance R between the neutralizing brush 70 and the conductive film 33 was changed in the range of 3 to 7 mm, and the distance L between the neutralizing brush 70 and the photosensitive drum 23 was changed in the range of 5 to 7 mm. The measurement method of the density variance and the evaluation standard were same as those in the first embodiment shown in FIGS. 2 and 3.

As shown in FIGS. 10 and 11, when the ratio L/R was greater than one, the graininess value was maintained less than 1.0, thereby suppressing the density variance. However, when the ratio L/R was greater than 1.4, the effect of the neutralizing brush 70 for neutralizing the recording medium 100 diminished, so that the recording medium 100 tended to wind around the photosensitive drum 23.

Accordingly, when the distance L between the neutralizing brush 70 and the photosensitive drum 23 is greater than the distance R between the neutralizing brush 70 and the conductive film 33, or that the distance L between the neutralizing brush 70 and the photosensitive drum 23 is equal to or smaller than 1.4 times of the distance R between the neutralizing brush 70 and the conductive film 33, it is possible to prevent the neutralizing brush 70 from excessively charging the photosensitive drum 23 with the negative polarity, thereby minimizing the density variance. Further, it is possible to prevent the recording medium 100 from being wound around the photosensitive drum 23.

As described above, in the image forming apparatus 10 in the second embodiment, the image forming unit main body 22b is configured such that the distance L between the neutralizing brush 70 and the photosensitive drum 23 is greater than the distance R between the neutralizing brush 70 and the conductive film 33, or that the distance L between the neutralizing brush 70 and the photosensitive drum 23 is equal to or smaller than 1.4 times of the distance R between the neutralizing brush 70 and the conductive film 33. Accordingly, the neutralizing brush 70 effectively neutralizes the recording medium 100 charged with the positive polarity, so that the recording medium 100 is not wound around the photosensitive drum 23. Further, the conductive film 33 is provided for preventing the neutralizing brush 70 from excessively charging the photosensitive drum 23 with the negative polarity, thereby minimizing the density variance and making it possible to obtain an image with high quality.

The present invention is not limited to the first and second embodiments described above, and may be modified as follows. For example, in the first and second embodiments, the light source 25 is formed of the LEDs, and may be formed as a laser and the like.

Further, in the first and second embodiments, the image forming apparatus 10 is the monochrome image forming apparatus, and may be a color image forming apparatus of a four cycle type.

The disclosure of Japanese Patent Application No. 2010-245957, filed on Nov. 2, 2010, is incorporated in the application by reference.

While the invention has been explained with reference to the specific embodiments of the invention, the explanation is illustrative and the invention is limited only by the appended claims.

What is claimed is:

1. An image forming apparatus, comprising:
an image forming unit including an image supporting member for supporting a developer image;
a transfer device for transferring the developer image on the image supporting member to a front surface of a recording medium;
a neutralizing device disposed on a downstream side of the transfer device in a transportation direction of the recording medium and a side of a backside surface of the recording medium for neutralizing the recording medium; and
a blocking member disposed at a position to face the neutralizing device for blocking the image supporting member from the neutralizing device.

2. The image forming apparatus according to claim 1, wherein said blocking member is formed of a resin sheet.

3. The image forming apparatus according to claim 1, wherein said blocking member is disposed at the position to face the front surface of the recording medium.

4. The image forming apparatus according to claim 1, wherein said image forming unit further includes a frame member, said blocking member being attached to the frame member.

5. The image forming apparatus according to claim 1, wherein said image supporting member includes a conductive supporting member and a photosensitive layer disposed on the conductive supporting member.

6. The image forming apparatus according to claim 1, wherein said neutralizing device is arranged away from the image supporting member by a distance between 5 mm and 7 mm inclusive.

7. The image forming apparatus according to claim 1, wherein said blocking member is arranged away from the image supporting member by a distance between 0.5 mm and 2.0 mm inclusive.

8. The image forming apparatus according to claim 1, wherein said neutralizing device is formed of a plurality of linear members made of stainless steel fibers, and is formed in a brush shape.

9. The image forming apparatus according to claim 8, wherein said blocking member is arranged at a position to cross over a straight line between the linear members and a rotational center point of the image supporting member.

10. An image forming apparatus, comprising:
an image forming unit including an image supporting member for supporting a developer image;
a transfer device for transferring the developer image on the image supporting member to a front surface of a recording medium;
a neutralizing device disposed on a downstream side of the transfer device in a transportation direction of the recording medium and a side of a backside surface of the recording medium for neutralizing the recording medium; and
a conductive member disposed at a position to face the neutralizing device.

11. The image forming apparatus according to claim 10, wherein said conductive member is formed of a conductive sheet.

12. The image forming apparatus according to claim 10, wherein said conductive member is disposed at the position to face the front surface of the recording medium.

13. The image forming apparatus according to claim 10, wherein said image forming unit further includes a frame member, said conductive member being attached to the frame member.

14. The image forming apparatus according to claim 10, wherein said image supporting member includes a conductive supporting member and a photosensitive layer disposed on the conductive supporting member.

15. The image forming apparatus according to claim 10, wherein said neutralizing device is disposed away from the image supporting member by a distance greater than a distance between the neutralizing device and the conductive member and equal to or smaller than 1.4 times of the distance between the neutralizing device and the conductive member.
